(19) United States
(12) Patent Application Publication
(10) Pub. No.: US 2008/0011127 A1
(43) Pub. Date: Jan. 17, 2008

(54) MULTI-PURPOSE CONTAINER OPENER

(76) Inventor: Robert Mazur, Canton, MI (US)

Correspondence Address: BUTZEL LONG, 350 SOUTH MAIN STREET, SUITE 300, ANN ARBOR, MI, 48104, US

(21) Appl. No.: 11/769,810

(22) Filed: Jun. 28, 2007

Related U.S. Application Data
(60) Provisional application No. 60/816,975, filed on Jun. 28, 2006.

(51) Int. Cl. B67B 7/44; B67B 7/18

(52) U.S. Cl. 81/3.09

(57) ABSTRACT

A multi-purpose closure opening device for opening the closures of a variety of containers which includes a flexible body that having a top surface and a bottom surface and at least two recesses formed in the bottom surface of the flexible body. Each of the at least two recesses is surrounded by peripheral walls that have gripping structures which extend inward from each of the peripheral walls. A rigid reinforcing structure is embedded in the flexible body for reinforcing one of the at least two recesses formed in a bottom surface of the flexible body. A prying structure for prying closures from containers is attached to the reinforcing structure and extends outward from a side of the flexible body.

### RELATED APPLICATION

The present application is based upon U.S. Provisional Patent Application Ser. No. 60/816,975, filed Jun. 28, 2006 to which priority is claimed under 35 U.S.C. §120 and of which the entire specification is hereby expressly incorporated by reference.

### TECHNICAL FIELD

The present invention relates to multi-purpose closure openers for containers. More particularly, the present invention relates to a multi-purpose closure opener that is a unitary structure that combines rigid and non-rigid or resilient elements for opening and manipulating a wide variety of container closures.

### BACKGROUND ART

Many forms of containers are known which are provided with a closure member that is attached thereto by a locking arrangement which requires relative angular displacement between the container and closure member. In order to release the closure member from the container it is necessary to impart some angular displacement of the closure member relative to the container. One example of this form of closure is a screw cap often used as a closure member for a bottle. Another example is a closure connected to a container by a bayonet connection that is often used on medicine containers.

Many containers provided with closure members of this type are in everyday household use and too often the opening of such a container presents a serious problem for some individuals.

Twist-top bottle cap openers, lid openers for jars, medicine container openers, and tab-top can openers, are known. Typically these types of openers are provided as separate implements and are found in the kitchens of many homes and used on a frequent basis. Having such separate openers takes up considerable space and causes clutter in kitchen drawers or shelves where they are each normally stored.

Multi-purpose container openers have been developed and are exemplified in the disclosures of U.S. Pat. No. 2,568,612 to Cullen, U.S. Pat. No. 3,570,028 to de la Hitte, U.S. Pat. No. 3,751,743 to Buck, U.S. Pat. No. 4,633,740 to Jacobs, U.S. Pat. No. 4,867,622 to Phillips, U.S. Pat. No. 6,070,497 to Fartelli, U.S. Pat. No. 6,105,468 Fohrman et al., and U.S. Pat. No. 7,028,359 to Mazur and U.S. Design Patent No. D492,557 to Mazur.

The present invention is directed to a multi-purpose container opening device that combines rigid and non-rigid or resilient elements for opening and manipulating a wide variety of container closures.

### DISCLOSURE OF THE INVENTION

According to various features, characteristics and embodiments of the present invention which will become apparent as the description thereof proceeds, the present invention provides a multi-purpose closure opening device for opening the closures of a variety of containers which includes:

a flexible body that includes a top surface and a bottom surface;

at least two recesses formed in the bottom surface of the flexible body,

peripheral walls surrounding the periphery of each of the at least two recesses formed in a bottom surface of the flexible body;

gripping structures extending inward from each of the peripheral walls; and

a rigid reinforcing structure embedded in the flexible body which reinforces one of the at least two recesses formed in a bottom surface of the flexible body.

The present invention further provides multi-purpose closure opening device for opening the closures of a variety of containers which includes a flexible body having a plurality of recesses that are configured to receive different sized container closures and a rigid reinforcing structure that is embedded in the flexible body and includes a frangible structure.

### BRIEF DESCRIPTION OF DRAWINGS

The present invention will be described with reference to the attached drawings which are given as non-limiting examples only, in which:

FIG. 1 is a planar top view of a multi-purpose container opening device according to one embodiment of the present invention.

FIG. 2 is a planar bottom view of the multi-purpose container opening device of FIG. 1.

FIG. 3 is a side view of the multi-purpose container opening device of FIG. 1.

FIGS. 4-6 depict how the smaller portion of the multi-purpose container opening device can be used to remove a closure from a container.

FIGS. 7-8 depict how the main portion of the multi-purpose container opening device can be used to remove a closure from a container.

FIGS. 9-10 depict how the prying structure(s) of the multi-purpose container opening device can be used to pry a closure from a container.

FIGS. 11-12 depict a reinforcing structure according to another embodiment of the present invention.

### BEST MODE FOR CARRYING OUT THE INVENTION

The present invention is directed to a multi-purpose container opening device that can be used for opening and manipulating a wide variety of container closures, including, but not limited to, screw caps, closures that connect to a container by a bayonet connection, such as those used on medicine containers, snap on closures, pry off closures, push and turn closures, squeeze and turn closures, etc. The multi-purpose container opening device of the present invention is further configured to open closures of different sizes (e.g. diameters).

The multi-purpose container opening device of the present invention is made from a combination of rigid materials and non-rigid or resilient materials. Examples of rigid materials that can be used and incorporated into the multi-purpose container opening device of the present invention include moldable plastic materials, metals that can be molded, cast or machined, and other suitable rigid materials. Examples of non-rigid, resilient materials include materials such as such as rubber materials, blends of plastics and elastomers and other materials that are flexible for purposes of the present invention as will be understood as the description thereof proceeds.

According to one embodiment, the multi-purpose container opening device of the present invention is configured to be in the shape of a cat, a dog, a rabbit, or other domestic and non-domestic animals. In further embodiments, the multi-purpose container opening device of the present invention can be configured to have any desired shape, including geometric or non-geometric shapes.

According to one embodiment, the multi-purpose container opening device of the present invention includes at least one non-rigid, resilient portion that is configured to be able to grasp container covers that have different sizes. Further, the multi-purpose container opening device of this embodiment includes at least one non-rigid, resilient portion that is configured to grasp containers of a predetermined size or size range and is reinforced by a rigid portion or structure.

The reinforced non-rigid, resilient portion includes gripper features that can be used to grip or grasp a container closure and hold the container cover securely during and after the process of removing the container closure from a container. In addition, the reinforced non-rigid, resilient portion includes a resilient area or portion that can be pressed to release or eject a removed container closure that is otherwise held by the gripping features after removal from a container.

According to another embodiment of the multi-purpose container opening device of the present invention includes a rigid portion that functions as a prying lever which, together with a prying tip, allows a user to pry a container off of a container.

The prying lever can be either a separate element or continuous with the rigid portion that reinforces the reinforced non-rigid, resilient portion of the multi-purpose container opening device.

The present invention will be hereafter described with reference to the attached drawings, which depict, for descriptive purposes, an embodiment of the present invention which is configured in the shape of a cat. It is nevertheless to be understood, as discussed above, that the multi-purpose container opening device of the present invention can be configured to be in the shape of any animal such as a cat, dog, rabbit, etc, or can have any desired shape, including geometric or non-geometric shapes. It is believed that the description of the multi-purpose container opening device of the present invention made in reference to the shape of a cat will enable those skilled in the art to configure the multi-purpose container opening device in other shape or shapes.

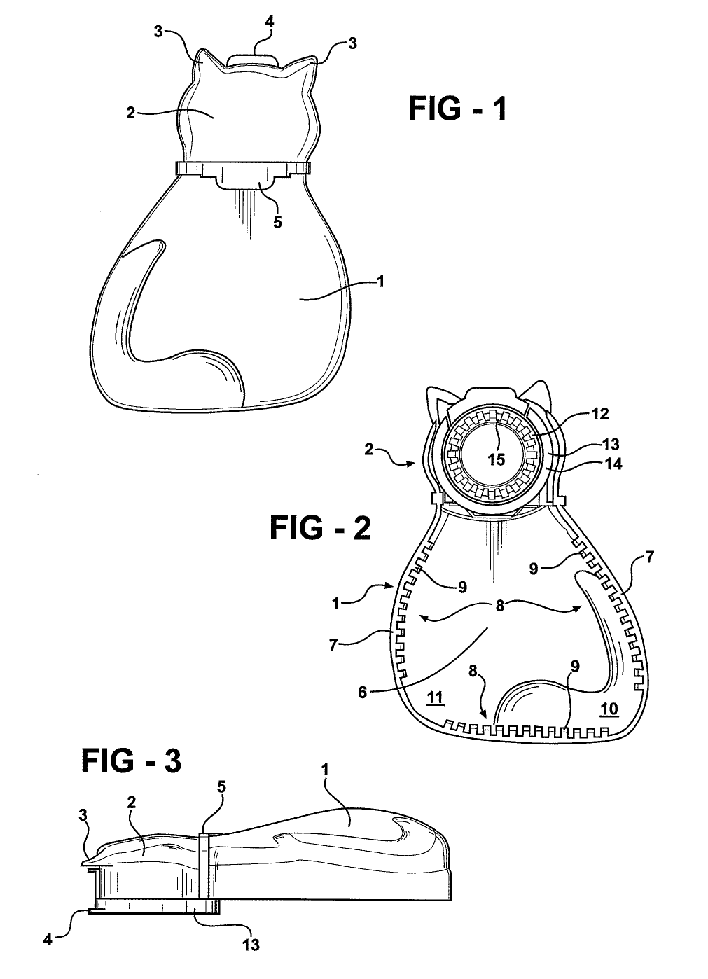

FIG. 1 is a planar top view of a multi-purpose container opening device according to one embodiment of the present invention. The multi-purpose container opener shown in FIG. 1 is has a main body portion 1 and a smaller portion 2 that is connected with or coupled to the main body portion 1. In the depicted embodiment the main body portion 1 is configured to resemble the body of a cat and the smaller portion 2 is configured to resemble the head of a cat. The smaller portion 2 includes two projections 3 that extend outward and are, in this embodiment, configured to resemble the ears of a cat. Between the two projections 3 one or more small rigid prying projections 4 (one shown) extend outward for purposes of prying closures from containers as discussed in more detail below. Between the main body portion 1 and the smaller portion 2 there is a rigid structure 5 that is coupled to the prying projection(s) 4 as discussed below. In the depicted embodiment, this rigid structure 5 is configured to resemble a collar warm by the overall cat shape.

FIG. 2 is a planar bottom view of the multi-purpose container opening device of FIG. 1. has shown in FIG. 2 the bottom or underside of the multi-purpose container opening device includes recessed areas in both the main body portion 1 and the smaller portion 2. In the main body portion 1 the central recessed area 6 has a wall 7 that extends along the periphery of the main body portion 1 at the underside except along the area between the main body portion 1 and the connecter smaller portion 2. As shown, the wall 7 that surrounds the main body portion 1 includes portions 8 that are formed with a series of inward projecting gripping structures 9. These inward projecting gripping structures 9 which can be in the form of ribs, dimples, etc. can be integrally molded into the wall 7 at the time the main body portion 1 is formed and are used to grip a container closure for purposes of applying a twisting force to a container closure. The main body portion 1, including wall 7 is made from non-rigid or resilient materials such as rubber materials and elastomer blends that are flexible for purposes of allowing the opposite sides or other portions of the wall 7 to be squeezed, by hand together, so that the gripping structures 9 can engage a container closure for purposes of twisting the closure and removing it from a container such as a container or jar. As noted, the shape of the main body portion 1 includes a non-symmetrical shape having two or more corners 10 and 11 that have different sizes. In use, smaller diameters closures can be removed by positioning them in or near the smaller corner 10 and then squeezing the wall 7 (having gripping structures 9) against the closure to grip the closure. Larger diameter closures can be removed by positioning them in or near the larger corner 11 and then squeezing the wall 7 (having gripping structures 9) against the closure to grip the closure. Finally, even larger diameter closures can be removed by positioning them in or near the center of the main body portion 1 and then squeezing the wall 7 (having gripping structures 9) against the closure to grip the closure.

The smaller portion 2 of the multi-purpose container opening device includes a circular wall 12 that is surrounded by a reinforcing rigid structure 13. The reinforcing rigid structure 13 can be insert-molded into the smaller portion 2 or inserted and secured after the smaller connected portion 2 is molded (together with the main body portion 1). As shown, the reinforcing rigid structure 13 includes an annular shaped portion 14 that can be visible from the bottom of the multi-purpose container opening device. The circular wall 13 of the smaller portion 2 is made from a non-rigid or resilient material such as rubber materials and elastomer blends and is formed with inward projecting gripping structures 15 which can also be in the form of ribs, dimples, etc. and can be integrally molded into the circular wall 12 at the time the smaller portion 2 is formed and are used to grip a container closure for purposes of applying a twisting force to a container closure. In use, a container closure such as a soft drink screw cap is received within the circular wall 12 and engaged by the gripping structures 15 so that as the gripping structures 15 compress against the reinforcing rigid structure 13 the screw cap becomes forcefully engaged and can be twisted by rotating the multi-purpose container opening device with respect to the container to which the screw cap is attached. After being removed from the container, the screw cap remains engaged by the gripping structures 15 and can be removed or ejected from the connected small portion of the multi-purpose container opening device by pressing downward on the non-rigid, resilient center of the smaller portion 2 as discussed in more detail below.

As indicated above, the rigid structure 13 is coupled to the prying projection(s) 4 so that the prying structure(s) or projections 4 extend outward from the smaller portion 2 on the multi-purpose container opening device.

FIG. 3 is a side view of the multi-purpose container opening device of FIG. 1. FIG. 3 shows one configuration in which the prying projection(s) 4 is coupled to the reinforcing structure 13 so as to extend outward from the smaller portion 2 of the multi-purpose container opening device. In this depicted embodiment, the reinforcing structure 13 and prying projection(s) 4 are shown as extending beyond the lower surfaces of the main body portion 1 and the smaller portion 2. In alternative embodiments, the reinforcing structure 13 and prying projection(s) 4 can be incorporated into the multi-purpose container opening device so as to be substantially flush with the lower surfaces of the main body portion 1 and the smaller portion 2.

The embodiment of the invention shown in FIG. 3 depicts the protections 3 being formed near the upper portion of the multi-purpose container opening device and the prying structure(s) 4 as being formed near the lower portion of the multi-purpose container opening device so that there is a gap between the projections 3 and the prying structure(s) 4. In alternative embodiments, the projections 3 can extend between the full height of the multi-purpose container opening device (or any portion of the full height) and the prying structure(s) 4 can be positioned between the projections 3.

FIG. 3 illustrates one embodiment of how the reinforcing structure 13 that surrounds the circular wall 12 can be coupled to the rigid structure 5 that is provided between the main body portion 1 and the smaller portion 2 and that is positioned at the upper surface of the multi-purpose container opener. Access to this rigid structure 5 according to one embodiment of the present invention can be used to apply a prying force to prying structure(s) 4 as discussed in detail below. Otherwise, the small portion 2 which has the reinforcing structure 13 therein can be lifted up apply a prying force to prying structure(s) 4.

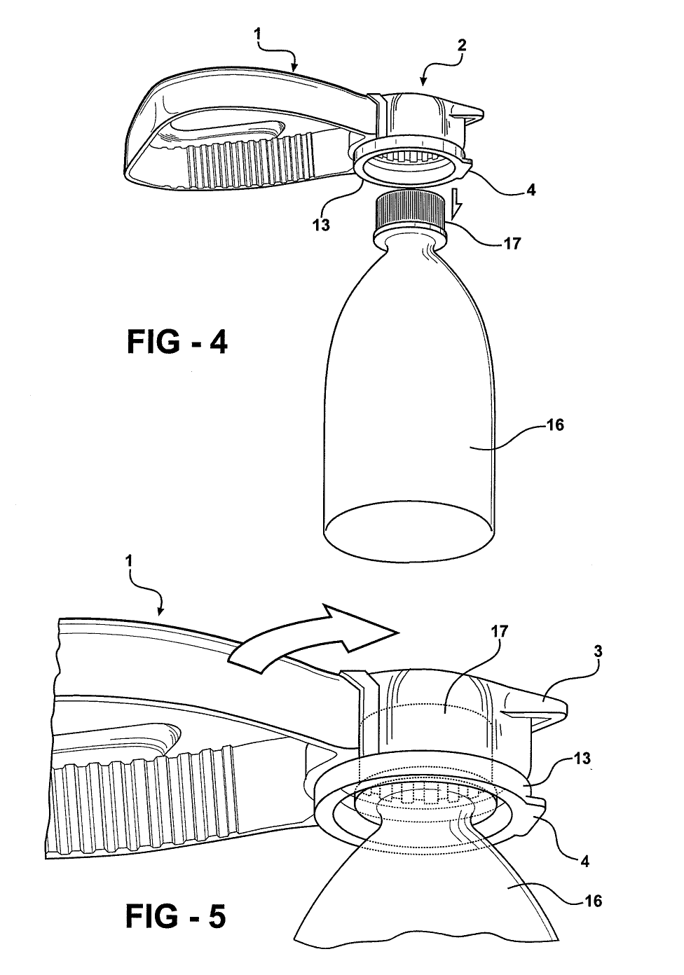

FIGS. 4-6 depict how the smaller portion of the multi-purpose container opening device can be used to remove a closure from a container. In FIG. 4 a container 16 is depicted that is closed by a screw cap 17 which may or may not have a lower rupturable ring. To remove the screw cap 17, the screw cap 17 with the attached container 16 is aligned with the multi-purpose container opening device so that the screw cap 17 can be received within circular wall 12. As the screw cap 17 is pushed into the circular wall 12 the gripping structures 15 provided on and extending inward from the circular wall 12 are compressed against the surrounding reinforcing structure 13. As a result, the gripping structures 15 forcefully grip the sides of the screw cap 17 so that rotating the multi-purpose container opening device in a counter-clockwise direction effects unscrewing and removal of the screw cap 17 from the container 16.

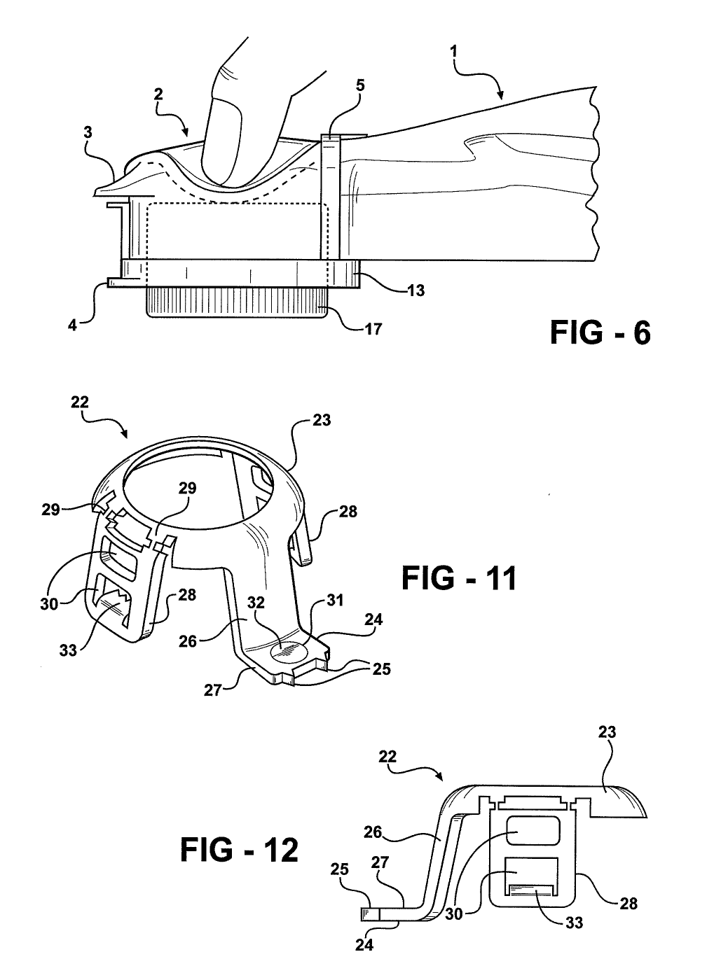

As shown in FIG. 6, after the screw cap 17 is removed from the container 16 it remains held by the gripping structures 15 in the small portion 2 of the multi-purpose container opening device. To remove the screw cap 17 from the small portion 2 of the multi-purpose container opening device, one pushes on the resilient upper surface of the multi-purpose container opening device above the center of the smaller portion 2 as shown in FIG. 6 to push out or eject the screw cap 17 from the gripping force of the gripper structures 15.

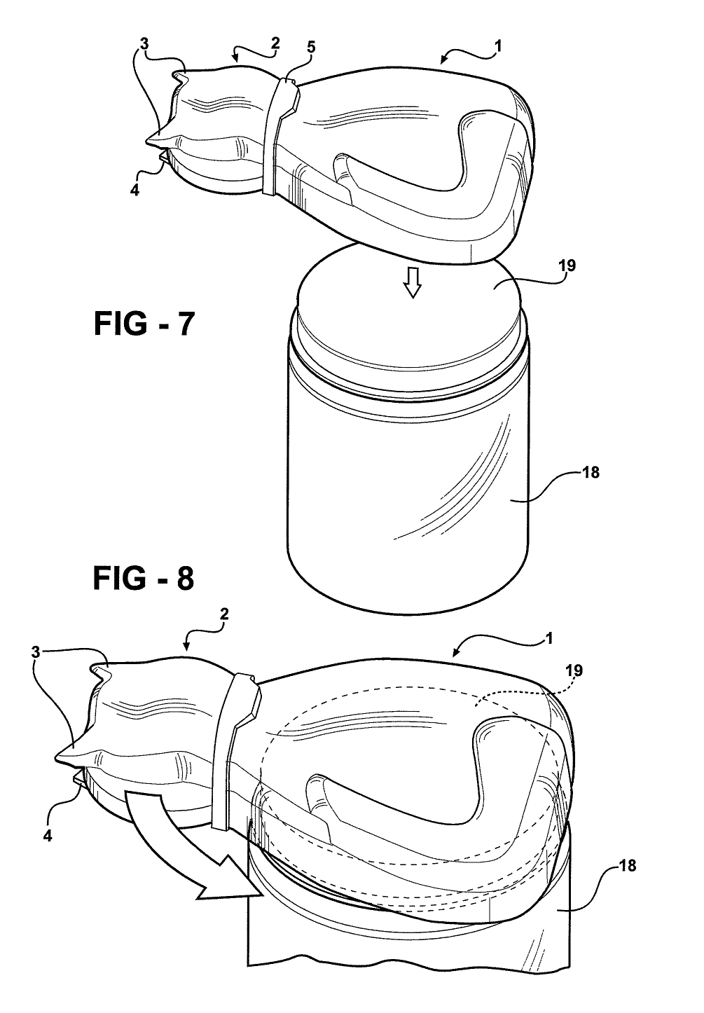

FIGS. 7-8 depict how the main portion of the multi-purpose container opening device can be used to remove a closure from a container. In FIG. 7 a container, e.g., jar 18 is depicted that is closed by a screw cap 19. In order to unscrew and remove the screw cap 19, the jar 18 is aligned with the multi-purpose container opening device so that the screw cap 19 is received within the peripheral wall 7 of the main body portion 1 of the multi-purpose container opening device. Once received within the peripheral wall 7, the main body portion 1 of the multi-purpose container opening device is squeezed, by hand, so that the gripping structures 9 on the peripheral wall 7 engage and grip against the outer surface of the screw cap 19. While squeezing and gripping the screw cap 19 the multi-purpose container opening device is rotated counter clockwise to unscrew the screw cap 19 from the jar 18 as shown in FIG. 8.

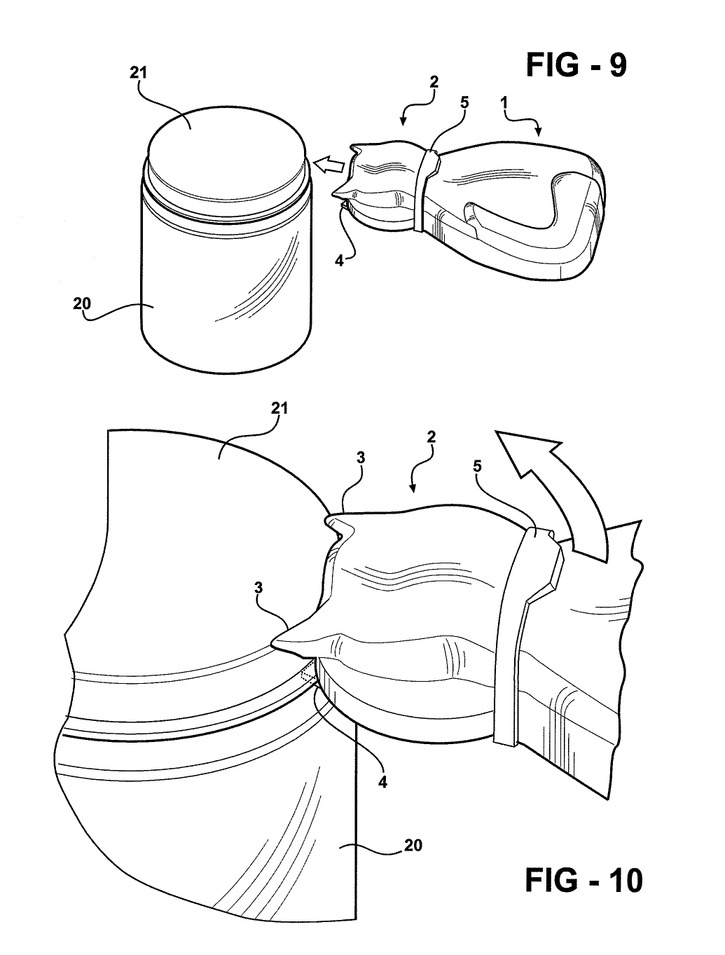

FIGS. 9-10 depict how the prying structure(s) 4 of the multi-purpose container opening device can be used to pry and remove a closure from a container. In FIG. 9 a container 20 is depicted as being closed by a closure 21. In order to pry and remove the closure 21 from the container 20, the prying structure(s) 4 of the multi-purpose container opening device is inserted against a side of the container 20 just below the lower edge of the closure 21. To remove the closure 21 the opposite end of the multi-purpose container opening device is lifted up so that the distal end of the prying structure(s) pivots against the side of the container 20 causing the prying structure(s) 4 to lift the lower edge of the closure 21 upward and remove the closure 21. Since the main body portion 1 of the multi-purpose container opening device is made from a non-rigid, resilient material, it may be difficult to achieve a prying force by lifting the end of the main body portion. Therefore, the rigid structure 5 that is between the main body portion 1 and the smaller portion 2 can be provided at an upper surface of the multi-purpose container opening device and configured to be engaged by one's finger and used to apply an upward prying force to the prying structure(s) 4 and thereby remove the closure 21.

FIGS. 11-12 depict a reinforcing structure 22 according to another embodiment of the present invention that is designed and configured to be insert-molded at the time the multi-purpose container opening device, including the main body portion 1 and the smaller portion 2, are formed by a molding process. The reinforcing structure 22 includes an annular portion 23 that is configured to reinforce the circular wall 12 of the smaller portion 2 of the multi-purpose container opening device. A prying structure 24 having two spaced apart projections 25 extends downward from the annular portion 23 of the reinforcing structure 22. The prying structure 24 includes an axially extending portion 26 and a lower radially extending portion 27 from which the spaced apart projections 25 extend. The prying structure 24 can be used to pry a closure from a container. The projections 25 can be used to pierce and cut or tear plastic or paper labels or shrink-wrap seals that might extend over a closure. The reinforcing structure 22 further includes two or more axially extending legs 28 (two shown) which are configured to extend axially along the portions of the circular wall 12 of the smaller portion 2 of the multi-purpose container opening device. Legs 28 are connected to the annular portion 22 with weakened or frangible structures that are exemplified by narrowed structural portions 29 in FIG. 11. These weakened or frangible structures are designed to allow the legs 28 to break free and separate from the annular portion 23 after the reinforcing structure 2 is insert-molded into the multi-purpose container opening device of the present invention. As shown, the legs 28 include inwardly directed tooth structures 33 that form opposed jaw elements. When molded into the multi-purpose closure opening device of the present invention, the tips of these toothed structures can extend inwardly and be exposed within the recess formed in smaller portion 2 so that they extend inwardly from the circular wall 12. By allowing the legs 28 to break free and separate from the annular portion 23, the legs 28 will be pivotable (due to the surrounding non-rigid or resilient material from which the flexible main body portion 1 and smaller portion 2 are molded) about the ruptured junction of the legs 28 with the annular portion 23. This provides a hinge effect whereby one can squeeze the sides of the smaller portion 2 and cause the toothed structures 33 to engage and grip the sides of a closure that is positioned within the circular wall 12 of the smaller portion 2 for removal of the closure from a container. As can be seen, the legs 28 are provided with openings 30 through which material can flow during the molding process for purposes of securing legs 28 in place in the final molded product.

The configuration of the prying structure 24 shown in FIG. 12 is such that, after the reinforcing structure 22 is insert molded in the multi-purpose closure opening device, the spaced apart projections 25 extend between the projections 3 that extend outward from the smaller portion 2 of the multi-purpose container opening device of the present invention so as to be aligned at or near the bottom surface of the device for purposes of prying off container closures. As can be understood the reinforcing structure 22 shown in FIGS. 11-12 eliminates the need for the reinforcing structure 13 that is shown in FIG. 2. Any necessary prying to remove a closure from a container can be achieved by lifting up on the small portion 2 of the multi-purpose closure opening device.

The reinforcing structure 22 shown in FIGS. 11-12 includes a bore 31 in the lower radially extending portion 27 of the prying structure 24. A magnet 32 can be inserted and secured into this bore 31 and used to attach the multi-purpose container opening device to a metal surface such as a refrigerator, stove, etc. Likewise, it is possible to provide and secure a magnet to the lower portion of the reinforcing rigid structure 13 of the multi-purpose container opening device shown in FIG. 2 or to any suitable subadjacent structure for purposes of attaching the multi-purpose container opening device to a metal surface such as a refrigerator, stove, etc.

According to a further embodiment of the present invention, the lower radially extending portion 27 of the prying structure 24 can include a tab or tang that extends inwardly from or near the junction of the radially extending portion 27 and the axially extending portion 26, which tab or tang can be configured to catch and open lift-off bottle caps.

Although the present invention has been described with reference to particular means, materials and embodiments, from the foregoing description, one skilled in the art can easily ascertain the essential characteristics of the present invention and various changes and modifications can be made to adapt the various uses and characteristics without departing from the spirit and scope of the present invention as described above.

What is claimed is:

1. A multi-purpose closure opening device for opening the closures of a variety of containers which comprises:
a flexible body that includes a top surface and a bottom surface;
at least two recesses formed in the bottom surface of the flexible body,
peripheral walls surrounding the periphery of each of the at least two recesses formed in a bottom surface of the flexible body;
gripping structures extending inward from each of the peripheral walls; and
a rigid reinforcing structure embedded in the flexible body which reinforces one of the at least two recesses formed in a bottom surface of the flexible body.

2. A multi-purpose closure opening device for opening the closures of a variety of containers according to claim 1, wherein the rigid reinforcing structure comprises an annular structure.

3. A multi-purpose closure opening device for opening the closures of a variety of containers according to claim 1, wherein the at least two recesses comprises a large recess and a small recess.

4. A multi-purpose closure opening device for opening the closures of a variety of containers according to claim 3, wherein the rigid reinforcing structure is aligned with the small recess.

5. A multi-purpose closure opening device for opening the closures of a variety of containers according to claim 1 further comprising a magnet coupled to the rigid reinforcing structure for attaching the multi-purpose closure opening device to a metal surface.

6. A multi-purpose closure opening device for opening the closures of a variety of containers according to claim 1, wherein the flexible body is made from a rubber material.

7. A multi-purpose closure opening device for opening the closures of a variety of containers according to claim 4, wherein the small recess is configured to receive a circular closure for removal from a container and retain the closure after removal from the container.

8. A multi-purpose closure opening device for opening the closures of a variety of containers according to claim 7, wherein the top surface of the flexible body is sufficiently flexible to be depressed and thereby eject a retained closure from the small recess.

9. A multi-purpose closure opening device for opening the closures of a variety of containers according to claim 1, wherein the flexible body is configured to be in the general shape of an animal.

10. A multi-purpose closure opening device for opening the closures of a variety of containers according to claim 1, further comprising a prying structure that extends outward from a side of the flexible body for prying closures from containers, wherein the prying structure is coupled to the rigid reinforcing structure.

11. A multi-purpose closure opening device for opening the closures of a variety of containers according to claim 3, wherein the large recess has at least two corners that have different shapes.

12. A multi-purpose closure opening device for opening the closures of a variety of containers according to claim 3, wherein the peripheral wall of the small recess is reinforced by the rigid reinforcing structure so that the gripping structure.

13. A multi-purpose closure opening device for opening the closures of a variety of containers according to claim 1, wherein the rigid reinforcing structure is made of a metal.

14. A multi-purpose closure opening device for opening the closures of a variety of containers according to claim 13, wherein the rigid reinforcing structure is formed with a frangible structure.

15. A multi-purpose closure opening device for opening the closures of a variety of containers according to claim 14, where the rigid reinforcing structure comprises an annular structure and at least one leg which is detached from the annular structure by the frangible structure.

16. A multi-purpose closure opening device for opening the closures of a variety of containers which comprises a flexible body having a plurality of recesses that are configured to receive different sized container closures and a rigid reinforcing structure that is embedded in the flexible body and includes a frangible structure.

17. A multi-purpose closure opening device for opening the closures of a variety of containers according to claim 16, wherein the rigid reinforcing structure comprises an annular portion and a plurality of legs that extend from the annular portion and the frangible structure is provided between the annular portion at least one of the plurality of legs.

18. A multi-purpose closure opening device for opening the closures of a variety of containers according to claim 16, wherein the rigid reinforcing structure further comprises a prying structure that extends outward from a side of the flexible body.

19. A multi-purpose closure opening device for opening the closures of a variety of containers according to claim 16, wherein the flexible body that includes a top surface and a bottom surface and the plurality of recesses are formed in the bottom surface of the flexible body.

20. A multi-purpose closure opening device for opening the closures of a variety of containers according to claim 16, wherein the plurality of legs include inward projecting toothed structures that are exposed through the flexible body for gripping a closure when squeezed together.

21. A multi-purpose closure opening device for opening the closures of a variety of containers according to claim 18, wherein the rigid reinforcing structure further comprises a tab or tang that is configured to catch and open lift-off bottle caps.
